(19) United States
(12) Patent Application Publication
(10) Pub. No.: US 2026/0329322 A1
(43) Pub. Date: Oct. 22, 2026

(54) VOLTAGE SUPPLY CIRCUIT AND METHOD FOR OPERATING THE SAME

(71) Applicant: TAIWAN SEMICONDUCTOR MANUFACTURING COMPANY LTD., HSINCHU (TW)

(72) Inventors: TAKASHI MATSUDA, HSINCHU (TW); SZU-CHUN TSAO, HSINCHU CITY (TW)

(21) Appl. No.: 19/182,679

(22) Filed: Apr. 18, 2025

(51) Int. Cl. G05F 3/24

(52) U.S. Cl. CPC G05F 3/24

(57) ABSTRACT

A voltage supply circuit is provided, which includes a reference voltage circuit and a voltage regulator. The reference voltage circuit is configured to receive a first power supply voltage, a second power supply voltage, and a first ground voltage, and is configured to generate a reference voltage based on the first power supply voltage and the second power supply voltage. The voltage regulator is coupled to the reference voltage circuit and is configured to receive the first reference voltage and generate a second reference voltage based on the first reference voltage. The first power supply voltage is higher than the second power supply voltage. The second ground voltage is between the first power supply voltage and the second power supply voltage.

### BACKGROUND

The semiconductor integrated circuit (IC) industry has produced a wide variety of devices to address issues in a number of different areas. Some of these devices have differing power requirements. As ICs have become smaller and more complex, operating voltages continue to decrease for optimizing IC performance.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a block diagram of a voltage supply circuit in accordance with some embodiments.

FIG. 2 is a block diagram of a voltage supply circuit in accordance with some embodiments of the present disclosure.

FIG. 3 is a schematic diagram of a reference voltage circuit in accordance with some embodiments of the present disclosure.

FIG. 4 is a schematic diagram of a low-dropout (LDO) regulator in accordance with some embodiments of the present disclosure.

FIG. 5 is a block diagram of a voltage supply circuit in accordance with some embodiments of the present disclosure.

FIG. 6 is a schematic diagram of a reference voltage circuit in FIG. 5.

FIG. 7 is flowchart of a method for operating a voltage supply circuit in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

In some embodiments, for an integrated circuit application that has a high-voltage (e.g., 1.85 V) input signal, a high-voltage device is used to deal with the high-voltage input signal. However, for some integrated circuit designs using certain processes, e.g., a 2 nm process, only low-voltage (e.g., 0.75 V) devices are available. If the low-voltage device is used as the input device of a high-voltage application, it will be over-stressed and cause potential unreliability due to the high-voltage input. For example, a voltage Vas across the gate and the source of a low-voltage transistor or a voltage V_{GD} across the gate and the source of the low-voltage transistor is not expected to be over a certain voltage value, e.g., 0.75V. If the voltage Vos or V_{GD} is subject to a voltage over that value, the transistor is over-stressed.

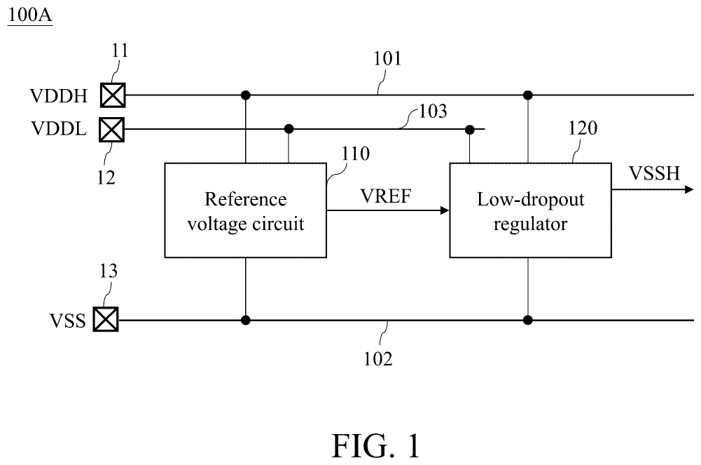

FIG. 1 is a block diagram of a voltage supply circuit in accordance with some embodiments.

In some embodiments, a first power supply voltage VDDH is provided to a power supply track 101 via terminal 11. A first reference voltage or a first ground voltage VSS is provided to a power supply track 102 via terminal 13. A second power supply voltage VDDL is provided to a power supply track 103 via terminal 12. Terminals 11, 12, and 13 may be input/output (I/O) pads electrically connected to an external power supply to receive the first power supply voltage VDDH, the first ground voltage VSS, and the second power supply voltage VDDL, respectively.

In some embodiments, the voltage supply circuit 100A is configured to receive the first power supply voltage VDDH, the second power supply voltage VDDL, and the first ground voltage VSS via power supply tracks 101, 103, and 102, respectively. The voltage supply circuit 100A is further configured to generate a second ground voltage VSSH using the first power supply voltage VDDH and the second power supply voltage VDDL. In some embodiments, the first power supply voltage VDDH is higher than the second power supply voltage VDDL. The first ground voltage VSS may be a ground voltage (e.g., 0V). The first power supply voltage VDDH and the second power supply voltage VDDL may vary depending on the technology node. For purposes of description, the first power supply voltage VDDH is approximately 1.85V, and the second power supply voltage VDDL is approximately 0.75V for a 2 nm process, but the present disclosure is not limited thereto. The second ground voltage VSSH is between the first power supply voltage VDDH and the second power supply voltage VDDL.

In some embodiments, the voltage supply circuit 100A may be implemented using low-voltage devices (not shown in FIG. 1). The low-voltage devices each may be a low-voltage transistor. The voltage difference between any two terminals (e.g., including gate, drain, and source terminals) of each low-voltage transistor should within a predetermined stress voltage threshold. The predetermined stress voltage threshold is lower than a first power supply voltage VDDH.

In some embodiments, the low-voltage device in the voltage supply circuit may be divided into a first portion and a second portion. The first portion of the low-voltage devices may be a high-side logic which operates within a first voltage domain. The second portion of the low-voltage devices may be a low-side logic which operates within a second voltage domain. The first voltage domain ranges from the second ground voltage VSSH to the first power supply voltage VDD. The second voltage domain ranges from the first ground voltage VSS to the second power supply voltage VDDL. More specifically, the voltage difference between the first power supply voltage VDD and the first ground voltage VSS is equal to or lower than the predetermined stress voltage threshold. The voltage difference between the second power supply voltage VDDH and the second ground voltage VSSH is equal to or lower than the predetermined stress voltage threshold. Accordingly, the first voltage domain ensures that the low-voltage devices within the high-side logic to operate within a safe voltage range, and the second voltage domain ensures that the low-voltage devices within the low-side logic to operate within a safe voltage range.

In some embodiments, the first voltage domain can be regarded as a high-side voltage domain, and the second voltage domain can be regarded as a low-side voltage domain. In some embodiments, the first power supply voltage VDDH serves as the power supply voltage of the high-side logic, while the second ground voltage VSSH serves as the ground voltage of the high-side logic. Additionally, the second power supply voltage VDDL serves as the power supply voltage of the low-side logic, while the first ground voltage VSS serves as the ground voltage of the low-side logic.

In some embodiments, when the low-voltage devices in the voltage supply circuit 100 operate within the voltage range from the first ground voltage VSSH to the first power supply voltage VDDH, it indicates that the low-voltage devices are over-stressed, which may lead to potential damage.

In some embodiments, the voltage supply circuit 100A includes a reference voltage circuit 110 and a low-dropout (LDO) regulator 120. The reference voltage circuit 110 is configured to receive the first power voltage VDDH, the second power supply voltage VDDL, and the first ground voltage VSS. The reference voltage circuit 110 is further configured to generate a reference voltage VREF based on the first power supply voltage VDDH and the second power supply voltage VDDL. The LDO regulator 120 is configured to receive the first power voltage VDDH, the second power supply voltage VDDL, the first ground voltage VSS, and the reference voltage VREF generated by the reference voltage circuit 110. The LDO regulator 120 is further configured to generate the second ground voltage VSSH based on the reference voltage VREF. In some embodiments, the second ground voltage VSSH, which serves as the reference voltage of the high-side logic, can be used to control p-type switch transistors in subsequent circuits of the voltage supply circuit 100A.

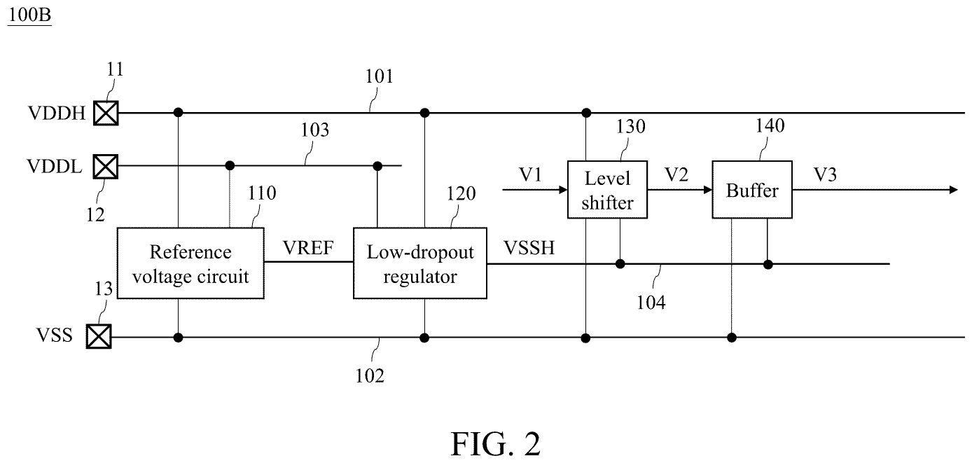

FIG. 2 is a block diagram of a voltage supply circuit in accordance with some embodiments of the present disclosure.

In some embodiments, the voltage supply circuit 100B shown in FIG. 2 is similar to the voltage supply circuit 100A shown in FIG. 1, with the difference being that the voltage supply circuit 100B further includes a level shifter 130 and a buffer 140, as depicted in FIG. 2.

In some embodiments, the reference voltage VREF generated by the reference voltage circuit 110 equals to VDDH−VDDL, which is approximately 1.85V−1.1V=0.75V. This indicates that the reference voltage VREF is within the predetermined stress voltage threshold of the low-voltage devices of the power supply circuit 100B. It should be noted that the reference voltage circuit 110 is configured to provide the reference voltage VREF to the LDO regulator 120, and the reference voltage circuit 110 may not have a strong driving capability compared to the LDO regulator 120.

In some embodiments, the second ground voltage VSSH generated by the LDO regulator 120 equals to VDDH−VDDL, which is approximately 0.75V. The second ground voltage VSSH is provided to a power supply track 104, as depicted in FIG. 2.

In some embodiments, the level shifter 130 is coupled to the power supply tracks 101, 102, and 104 to receive the first power supply voltage VDDH, the first ground voltage VSS, and the second ground voltage VSSH, respectively. The level shifter 130 is configured to convert the voltage range of a first voltage signal V1, which is within the second voltage domain (e.g., ranging from VSS to VDDL), to generate a second voltage signal V2. The second voltage signal V2 is within the first voltage domain (e.g., ranging from VSSH to VDDH).

In some embodiments, the buffer 140 is coupled to the power supply tracks 102 and 104 to receive the first ground voltage VSS and the second ground voltage VSSH, respectively. In some embodiments, the buffer 140 is further coupled to the power supply track 101 to receive the first power supply voltage VDDH. The buffer 140 is configured to receive and buffer the second voltage signal V2 to generate a third voltage signal V3, which is also within the first voltage domain. In some embodiments, the buffer 140 may be designed to provide a high driving capability of the third voltage signal V3.

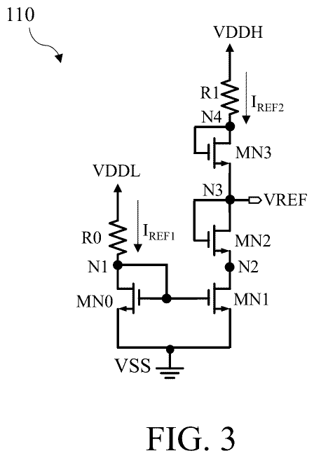

FIG. 3 is a schematic diagram of a reference voltage circuit in accordance with some embodiments of the present disclosure. Please refer to FIG. 2 and FIG. 3 simultaneously.

The schematic diagram of the reference voltage circuit 110 in FIG. 1A or FIG. 1B is illustrated in FIG. 3. In some embodiments, the reference voltage circuit 110 includes transistors MN0 to MN3 and resistors R0 and R1. Resistor R0 is coupled between the second power supply voltage VDDL and node N1. In some embodiments, transistors MN0 to MN3 may be n-type transistors. In some embodiments, transistors MN0 to MN3 are substantially the same in threshold voltage and size. It should be noted that, unless particularly specified otherwise, when it is mentioned that a transistor matches another transistor of the same type, it indicates that these two transistors are equivalent in threshold voltage and size. For example, the size may refer to a width-to-length ratio (W/L) of a planar device, a number of fins for a fin field-effect-transistor (finFET), and a number of nanosheets or nanowires for a nanosheet FET.

In some embodiments, a gate terminal of transistor MN0 is coupled to node N1. A drain terminal of transistor MN0 is coupled to node N1. A source terminal of transistor MN0 is configured to receive the first ground voltage VSS.

In some embodiments, a gate terminal of transistor MN1 is coupled to node N1. A drain terminal of transistor MN1 is coupled to node N2. A source terminal of transistor MN1 is configured to receive the first ground voltage VSS.

In some embodiments, a gate terminal of terminal of transistor MN2 is coupled to node N3. A drain terminal of terminal of transistor MN2 is coupled to node N3. A source terminal of terminal of transistor MN2 is coupled to node N2. Resistor R1 is coupled between the first power supply voltage VDDH and node N4.

In some embodiments, a gate terminal of terminal of transistor MN3 is coupled to node N4. A drain terminal of terminal of transistor MN3 is coupled node N4. A source terminal of terminal of transistor MN3 is coupled to node N3. Additionally, node N3 is an output terminal of the reference voltage circuit 110.

In some embodiments, transistor MN0 is in a diode-connected configuration, with its gate terminal and drain terminal being coupled together at node N1. Additionally, the gate and drain terminals of transistor MN0 are configured to receive the second power supply voltage VDDL through resistor R0. The second power supply voltage VDDL (e.g., approximately 0.75V) is higher than the threshold voltage Vₜₕₙ₀ (e.g., approximately 0.3V to 0.5V) of transistor MN0, activating transistor MN0. Accordingly, a reference current I_{REF1} flows from the second power supply voltage VDDL to the first ground voltage VSS through resistor R0 and transistor MN0. The reference current I_{REF1} can be expressed using equation (1) as follows.

$${I}_{REF 1} = \frac{( VDDL - {V}_{thn 0} )}{R 0} \qquad ( 1 )$$

Equation (1) can be rewritten into equation (2) as follows.

VDDL=I_{REF1}×R0+Vₜₕₙ₀ (2)

In some embodiments, transistors MN0 and MN1 form a current mirror. Thus, the reference current I_{REF1} flowing through transistor MN0 is mirrored by transistor MN1. Additionally, transistor MN3 is in a diode-connected configuration, with its gate terminal and drain terminal being coupled together at node N3. Transistor MN4 is also in a diode-connected configuration, with its gate terminal and drain terminal being coupled together at node N4. Furthermore, the drain terminal (e.g., node N4) is coupled to the first power supply voltage VDDH through resistor R1.

In some embodiments, the first power supply voltage VDDH (e.g., approximately 1.85V) is higher than the threshold voltage Vthn3 (e.g., approximately 0.3V to 0.5V) of transistor MN3, activating transistor MN3. Additionally, the gate voltage of transistor MN2 at node N3 is still higher than the threshold voltage Vthn2 (e.g., approximately 0.3V to 0.5V) of transistor MN2, activating transistor MN2. Given that transistors MN0 and MN1 matches each other, the reference current I_{REF2} mirrored by transistor MN1 is substantially equal to the reference current I_{REF1}. Furthermore, the reference current I_{REF2} flows from the first power supply voltage VDDH to the first ground voltage VSS through resistor R1, transistor MN3, transistor MN2, and transistor MN1, as depicted in FIG. 3.

In some embodiments, the reference voltage VREF generated at node N3 can be expressed using equation (3) as follows.

VREF=VDDH−I_{REF2}×R1−Vₜₕₙ₃ (3)

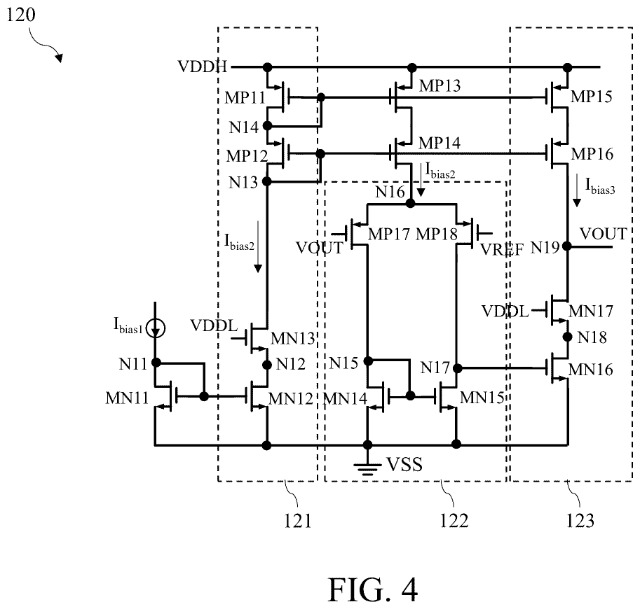

In some embodiments, because the reference currents IREF1 and IREF2 are substantially equal, when resistors R0 and R1 are substantially equal and the threshold voltages Vthn1 and Vthn3 are substantially equal, it indicates that (I_{REF2}×R1+Vₜₕₙ₃) substantially equals to VDDL. Therefore, the differential voltage (VDDH−VREF) is substantially equal to the second power supply voltage VDDL based on the equations (2) and (3), i.e., VDDH−VREF≅VDDL. As a result, the reference voltage VREF generated at the output terminal (e.g., node N3) of the reference voltage circuit 110 is substantially equal to (VDDH-VDDL), indicating that the reference voltage circuit 110 is capable of tracking the provided power supply voltages and generating the reference voltage VREF accordingly. The reference voltage VREF may serve as an input voltage of the LDO regulator 120 to generate the second ground voltage VSSH. Further details of the LDO regulator 120 are described with reference to FIG. 4 as follows.

FIG. 4 is a schematic diagram of a low-dropout (LDO) regulator in accordance with some embodiments of the present disclosure.

The schematic diagram of the LDO regulator 120 in FIG. 1A or FIG. 1B is illustrated in FIG. 4. In some embodiments, the LDO regulator 120 is configured to convert the reference voltage VREF to the second ground voltage VSSH. The LDO regulator 120 includes transistors MN11 to MN17 and transistor MP11 to MP18, as depicted in FIG. 4. In some embodiments, transistors MN11 to MN17 may be n-type transistors, and transistors MP11 to MP18 may be p-type transistors. For brevity, transistor MN11 matches transistor MN12, and transistor MN14 matches transistor MN15. Additionally, transistor MP11 matches transistors MP13 and MP15, transistor MP12 matches transistors MP14 and MP16, and transistor MP17 matches transistor MP18 in the embodiment of FIG. 4.

In some embodiments, a gate terminal of transistor MN11 is coupled to node N11. A drain terminal of transistor MN11 is coupled to node N11. A drain terminal of transistor MN11 is configured to receive the first ground voltage VSS. The drain terminal of transistor MN11 is configured to receive a bias current I_{bias1}, activating transistor MN11.

In some embodiments, a gate terminal of transistor MN12 is coupled to node N11. A drain terminal of transistor MN12 is coupled to node N12. A source terminal of transistor MN12 is configured to receive the first ground voltage VSS. In some embodiments, transistors MN11 and MN12 form a current mirror, and the bias current I_{bias1} flowing through transistor MN11 is mirrored by transistor MN12, indicating a bias current I_{bias2} flowing through transistor MN12 is substantially equal to the bias current I_{bias1}.

In some embodiments, a gate terminal of transistor MN13 is configured to receive the second power supply voltage VDDH. A drain terminal of transistor MN13 is coupled to node N13. A source terminal of transistor MN13 is coupled to node 12.

In some embodiments, a gate terminal of transistor MP11 is coupled to node N14. A source terminal of transistor MP11 is configured to receive the first power supply voltage VDDH. A drain terminal of transistor MP11 is coupled to node N14. A gate terminal of transistor MP12 is coupled to node N13. A source terminal of transistor MP12 is coupled to node N14. A drain terminal of transistor MP12 is coupled to node N13.

In some embodiments, a gate terminal of transistor MP13 is coupled to node N14. A source terminal of transistor MP13 is configured to receive the first power supply voltage VDDH. A drain terminal of transistor MP13 is coupled to a source terminal of transistor MP14. A gate terminal of transistor MP14 is coupled to node N13. A drain terminal of transistor MP14 is coupled to node N16.

In some embodiments, a gate terminal of transistor MP15 is coupled to node N14. A source terminal of transistor MP15 is configured to receive the first power supply voltage VDDH. A drain terminal of transistor MP13 is coupled to a source terminal of transistor MP16. A gate terminal of transistor MP16 is coupled to node N13. A drain terminal of transistor MP16 is coupled to node N19.

In some embodiments, transistor MP11 is in a diode-connected configuration, with its gate terminal and drain terminal being coupled together at node N14. Transistors MP12 is also in a diode-connected configuration, with its gate terminal and drain terminal being coupled together at node N13. Specifically, the voltage difference between the first power supply voltage VDDH and the first ground voltage VSS is large (e.g., approximately 1.85V), transistors MP11, MP12, MN13, and MN12 are arranged in a four-stage cascoded structure (or a stacked structure), which serves as an input stage 121 of the LDO regulator 120. This results in that the stress voltage for each of the transistors MP11, MP12, MN13, and MN12 is within the predetermined stress voltage threshold (e.g., 0.75V). For purposes of description, it is assumed the threshold voltage Vthn of N-type transistors MN11 to MN17 is 0.3V, and the threshold voltage |Vthp| of P-type transistors MP11 to MP18 is 0.3V. Specifically, the source voltage (e.g., at node N12) of transistor MN13 is equal to VDDL−Vthn. The voltage drop across transistors MP11, MP12, and MN13 is equal to 2*|Vthp|+V_{DS_MN13}, ensuring that the drain-to-source voltage of each of transistors MP11, MP12, and MN13 will not exceed the predetermined stress voltage threshold (e.g., 0.75V). In other words, transistor MN13 is used in the 4-stage cascoded structure to protect the drain-to-source voltage of transistors MP11 and MP12 from exceeding the predetermined stress voltage threshold (e.g., 0.75V).

In some embodiments, transistors MP11 and MP13 form a current mirror, and transistors MP11 and MP15 form another current mirror. Additionally, transistors MP12 and MP14 form yet another current mirror, and transistors MP12 and MP16 form yet another current mirror. Accordingly, the bias current I_{bias2} flowing through transistor MP11 is mirrored by transistor MP13, indicating a bias current I_{bias3} flowing through transistor MP13 is substantially equal to the bias current I_{bias2}. Additionally, the bias current I_{bias2} flows from the first power supply voltage VDDH to node N16 through transistors MP13 and MP14 in sequence.

Similarly, the bias current I_{bias2} flowing through transistor MP11 is also mirrored by transistor MP15, indicating a bias current I_{bias3} flowing through transistor MP13 is substantially equal to the bias current I_{bias2}. Additionally, the bias current I_{bias3} flows from the first power supply voltage VDDH to the first ground voltage VSS through transistors MP15, MP16, MN17, and MN16 in sequence.

In some embodiments, transistors MP17, MP18, MN14, and MN15 form a differential amplifier 122, with transistors MP17 and MP18 being an input transistor pair. For example, a gate terminal of transistor MP17 is configured to receive an output voltage VOUT of the LDO regulator 120. A source terminal of transistor MP17 is coupled to node N16. A drain terminal of transistor MP17 is coupled to node N15. A gate terminal of transistor MP18 is configured to receive the reference voltage VREF generated by the reference voltage circuit 110. A source terminal of transistor MP18 is coupled to node N16. A drain terminal of transistor MP18 is coupled to node N17. In some embodiments, the bias current I_{bias2} serves as the bias current of the differential amplifier 122. In some embodiments, the different amplifier 121 may further transistors MP13 and MP14.

In some embodiments, a gate terminal of transistor MN14 is coupled to node N15. A drain terminal of transistor MN14 is coupled node N15. A source terminal of transistor MN14 is configured to receive the first ground voltage VSS. A gate terminal of transistor MN15 is coupled to node N15. A drain terminal of transistor MN15 is coupled to node N17. A source terminal of transistor MN15 is configured to receive the first ground voltage VSS. In some embodiments, node N17 serves as an output terminal of the differential amplifier 122.

In some embodiments, transistor MN16 serves as a driver of the LDO regulator 120. A gate terminal of transistor MN16 is coupled to node N17. A drain terminal of transistor MN16 is coupled to node N18. A source terminal of transistor MN16 is configured to receive the first ground voltage VSS. In some embodiments, a gate terminal of transistor MN17 is configured to receive the second power supply voltage VDDL. A drain terminal of transistor MN17 is coupled to node N19. A source terminal of transistor MN17 is coupled to node N18. Node N19 serves as an output terminal of the LDO regulator 120.

In some embodiments, a gate terminal of transistor MP15 is coupled to node N14. A source terminal of transistor MP15 is configured to receive the first power supply voltage VDDH. A drain terminal of transistor MP15 is coupled to a source terminal of transistor MP16. A gate terminal of transistor MP16 is coupled to node N13. A drain terminal of transistor MP16 is coupled to node N19. It should be noted that transistors MP15, MP16, MN17, and MN16 form another 4-stage cascoded structure (or a stacked structure), which serves as an output stage 123 of the LDO regulator 120. Transistor MN17 is used in the 4-stage cascoded structure to protect the drain-to-source voltage of each of transistors MP15, MP16, and MN16 from exceeding the predetermined stress voltage threshold (e.g., 0.75V).

In some embodiments, the LDO regulators 120 can be implemented using low-voltage transistors, and the drain-source voltage, drain-gate voltage, and gate-source voltage of each low-voltage transistors therein is reduced to 0.75V or less using the second power supply voltage VDDL as a bias power supply voltage, thereby preventing the voltage difference between any two terminals of each low-voltage transistor from exceeding the predetermined stress voltage threshold (e.g., 0.75V).

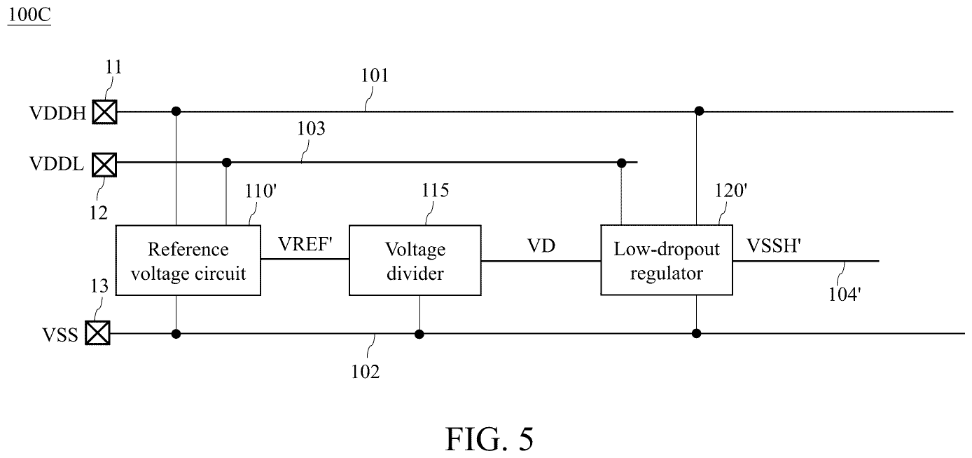

FIG. 5 is a block diagram of a voltage supply circuit in accordance with some embodiments of the present disclosure. Please refer to FIGS. 2, 4, and 5 simultaneously.

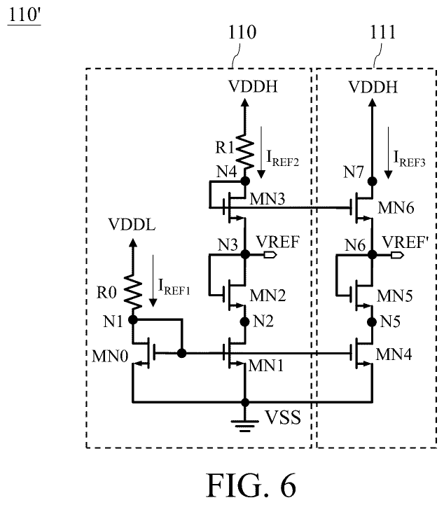

In some embodiments, the voltage supply circuit 100C shown in FIG. 5 may be similar to the voltage supply circuit 100B shown in FIG. 2, with the difference being that the circuit design of the reference voltage circuit 110′ and the LDO regulator 120′ differs from the reference voltage circuit 110 and the LDO regulator 120 shown in FIG. 2. Additionally, a voltage divider 115 is inserted between the reference voltage circuit 110′ and the LDO regulator 120′. The input voltages, including voltages VOUT and VREF, of the differential amplifier 122 should not exceed the predetermined stress voltage threshold to ensure the safety of the low-voltage devices within the differential amplifier 122. Further details of the reference voltage circuit 110′ will be described with reference to FIG. 6.

In some embodiments, the voltage divider 115 is configured to receive the reference voltage VREF′ generated by the reference voltage circuit 110, and divide the reference voltage VREF′ by a predetermined ratio N to generate a voltage signal VD (e.g., VD=VREF′/N), where N is a positive integer greater than 1. For purposes of description, N equals to 3 in FIG. 5. It should be noted that the predetermined ratio N can be appropriately designed according to practical needs.

In some embodiments, the circuit of the LDO regulator 120′ is similar to the LDO regulator 120 as shown in FIG. 4, within the difference being that the input voltage of transistor MP18 in FIG. 4 is replaced by the voltage signal VD of transistor MP18 in the LDO regulator 120′. In some embodiments, the LDO regulator 120′ is configured to receive the voltage signal VD generated by the voltage divider 115, and generate the second ground voltage VSSH′ using the voltage signal VD. This indicates that the input voltage of transistor MP18 in FIG. 4 is replaced by the voltage signal VD. Additionally, the voltage level of the voltage signal VD is lower than the predetermined stress voltage threshold of the low-voltage devices, preventing the differential input pair of the differential amplifier 122 from damage. In some embodiments, since the input voltage signal VD of the LDO regulator 120′ in FIG. 5 is lower than the input voltage signal (e.g., VREF) of the LDO regulator 120′ in FIG. 2, the second ground voltage VSSH′ generated by the LDO regulator 120′ may be slightly lower than the second ground voltage VSSH generated by the LDO regulator 120, and the low-voltage devices can still operate normally. In some embodiments, the power supply voltages provided to the subsequent circuits of the voltage supply circuit 100C may be processed by the level shifter 130 and buffer 140 shown in FIG. 2 to ensure that the low-voltage devices can operate within safe voltage ranges.

FIG. 6 is a schematic diagram of a reference voltage circuit in FIG. 5. In some embodiments, since the reference voltage VREF′ generated by the reference voltage circuit 110′ serves as an input voltage of the voltage divider 115, the reference voltage circuit 110′ need a higher driving capability to drive the elements in the voltage divider 115.

In some embodiments, the reference voltage circuit 110′ may be implemented using the reference voltage circuit 110 in FIG. 3 with a buffer 111, as depicted in FIG. 6. The operations about the reference voltage circuit 110 can be referred to in the embodiment of FIG. 3, and thus the details thereof will not be repeated here. In some embodiments, the buffer 111 includes transistors MN4, MN5, and MN6.

In some embodiments, a gate terminal of transistor MN4 is coupled to node N1. A drain terminal of transistor MN4 is coupled to node N5. A source terminal of transistor MN4 is configured to receive the first ground voltage VSS. A gate terminal of transistor MN5 is coupled to node N6. A drain terminal of transistor MN5 is coupled to node N6. A source terminal of transistor MN5 is coupled to node N5.

In some embodiments, a gate terminal of transistor MN6 is coupled to node N4. A drain terminal of transistor MN6 is coupled to node N7, and is configured to receive the first power supply voltage VDDH. A source terminal of transistor MN6 is coupled to node N6. In some embodiments, node N6 serves as an output terminal of the reference voltage circuit 110′.

In some embodiments, the voltage at node N4 is equal to VDDH−I_{REF2}*R1. Since the gate terminal of transistor MN6 is coupled to node N4, when the voltage at node N4 activates transistor MN3, it also activates transistor MN6. Transistor MN5 is in a diode-connected configuration, with its gate terminal and drain terminal being coupled together at node N6. Additionally, transistor MN0 and MN4 form a current mirror, indicating that the reference current I_{REF1} is mirrored by transistor MN4, and a reference current I_{REF3} flows from the first power supply voltage VDDH to the first reference voltage (e.g., ground) through transistors MN6, MN5, and MN4 in sequence.

In some embodiments, the buffer 111 may function as a driving stage of the reference voltage circuit 110′. For purposes of description, transistor MN0 matches transistors MN1 to MN5. Additionally, the size of transistor MN6 is larger than that of transistor MN3. For example, the size may refer to a width-to-length ratio (W/L) of a planar device, a number of fins for a fin field-effect-transistor (finFET), and a number of nanosheets or nanowires for a nanosheet FET. It should be noted that the ratio of the size of transistor MN6 to that of transistors of MN0 to MN5 can be appropriately designed according to practical needs.

In some embodiments, for brevity, transistors MN0 to MN6 are finFETs. When the number of fins of transistor MN3 is 2, the number of transistor MN6 is 20, but the present disclosure is not limited thereto. This indicates that the reference current I_{REF3} is approximately ten times the reference current I_{REF2}, thereby providing a high driving capability of the reference voltage VREF′ at node N6. Additionally, the drain terminal of transistor MN6 is configured to receive the first power supply voltage VDDH. This indicates that the reference voltage VREF′ generated at node N6 is closer to the first power supply voltage VDDH with a higher driving current (i.e., reference current I_{REF3}), achieving a higher driving capability of the reference voltage circuit 110′ in FIG. 6 compared to the reference voltage circuit 110 in FIG. 3.

In some embodiments, transistor MN0 matches transistors MN1 to MN3, and transistor MN4 matches transistor MN5 and MN6. The size of transistors MN4 to MN6 is multiple times (e.g., 10 to 20 times) larger than that of transistors MN1 to MN3. Accordingly, the reference current I_{REF3} is higher than the reference current I_{REF2}, thereby providing a high driving capability of the reference voltage VREF′ at node N6.

According to various embodiments of the present disclosure, a voltage supply circuit is provided. The voltage supply circuit is implemented using low-voltage devices which are divided into a high-side logic and a low-side logic operating in a first voltage domain and a second voltage domain, respectively. A first voltage range (e.g., from VSSH to VDDH) of the first voltage domain is higher than a second voltage range (e.g., from VSS to VDDL) of the second voltage domain. The voltage reference circuit of the voltage supply circuit is capable of tracking the provided power supply voltages (e.g., VDDH and VDDL) and generating a reference voltage (e.g., VREF) based on the provided power supply voltages. The LDO regulator of the power supply circuit is capable of generating a high-side ground voltage based on the reference voltage generated by the reference voltage circuit. The high-side ground voltage may serve as a high-side ground for the high-side logic operating in a first voltage domain. Additionally, using the circuit designs of the reference voltage circuit and LDO regulator, the voltage between any two terminal (e.g., including drain-source, gate-source, gate-drain voltages) of each low-voltage devices is kept within the predetermined stress voltage threshold, ensuring the safety of low-voltage devices.

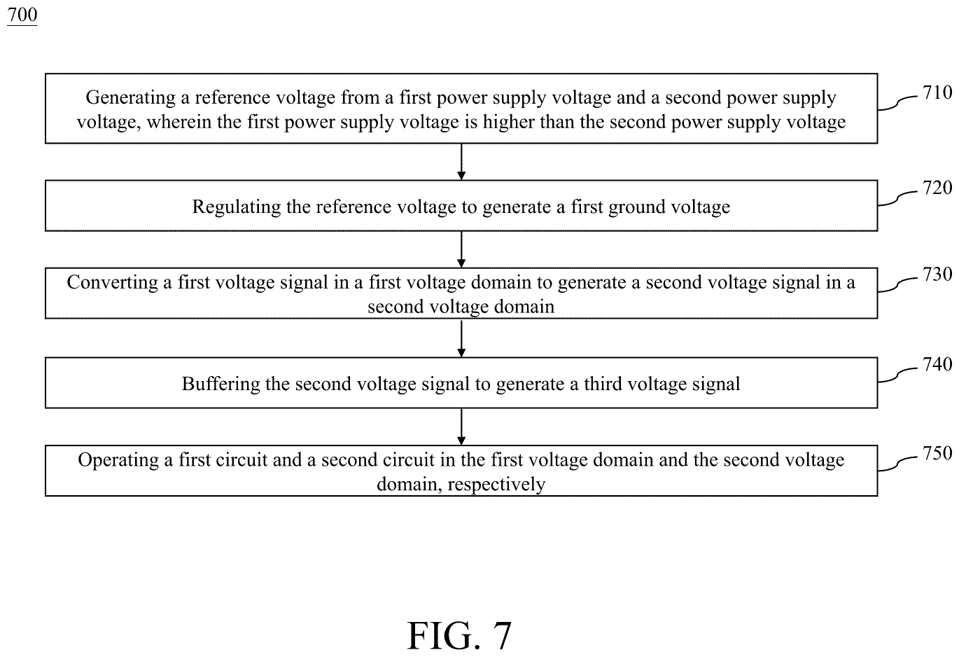

FIG. 7 is flowchart of a method for operating a voltage supply circuit in accordance with some embodiments of the present disclosure. Please refer to FIG. 2 and FIG. 7 simultaneously. Method 700 shown in FIG. 7 includes at least operations 710, 720, 730, 740, and 750. It should be noted that method 700 can include additional operations.

At operation 710, a reference voltage (e.g., VREF) is generated from a first power supply voltage (e.g., VDDH) and a second power supply voltage (e.g., VDDL), wherein the first power supply voltage is higher than the second power supply voltage. In some embodiments, the reference voltage circuit 110 is configured to generate the reference voltage VREF from the first power supply voltage VDDH and the second power supply voltage VDDL.

At operation 720, the reference voltage is regulated to generate a first ground voltage (e.g., VSSH). In some embodiments, the LDO regulator 120 is configured to regulate the reference voltage VREF to generate a first ground voltage VSSH.

At operation 730, a first voltage signal (e.g., V1) in a first voltage domain is converted to generate a second voltage signal (e.g., V2) in a second voltage domain. In some embodiments, the level shifter 130 is configured to convert a first voltage signal V1 in the first voltage domain (e.g., from VSS to VDDL) to a second voltage V2 in the second voltage domain (e.g., from VSSH to VDDH). In some embodiments, the first voltage signal equals to the second power supply voltage VDDL minus the second ground voltage (e.g., VSS).

At operation 740, the second voltage signal (e.g., V2) is buffered to generate a third voltage signal (e.g., V3). In some embodiments, the buffer 140 is configured to buffer the second voltage signal V2 to generate the third voltage signal V3.

At operation 750, a first circuit and a second circuit are operated in the first voltage domain and the second voltage domain. In some embodiments, the first circuit and the second circuit may be the low-side logic and the high-side logic. The first voltage domain ranges from a second ground voltage (e.g., VSS) to the second power supply voltage VDDL. The second voltage domain ranges from the first ground voltage (e.g., VSSH) to the first power supply voltage VDDH.

An aspect of the present disclosure provides a voltage supply circuit which includes a reference voltage circuit and a voltage regulator. The reference voltage circuit is configured to receive a first power supply voltage, a second power supply voltage, and a first ground voltage, and is configured to generate a reference voltage based on the first power supply voltage and the second power supply voltage. The voltage regulator is coupled to the reference voltage circuit and is configured to receive the reference voltage and generate a second ground voltage based on the reference voltage. The first power supply voltage is higher than the second power supply voltage. The second ground voltage is between the first power supply voltage and the second power supply voltage.

Another aspect of the present disclosure provides a voltage supply circuit which includes a reference voltage circuit, a voltage divider, and a voltage regulator. The reference voltage circuit is configured to receive a first power supply voltage, a second power supply voltage, and a first ground voltage, and is further configured to generate a first reference voltage based on the first power supply voltage and the second power supply voltage. The voltage divider is coupled to the reference voltage circuit and is configured to receive the first reference voltage and divide the first reference voltage by a predetermined factor to generate a second reference voltage. The voltage regulator is coupled to the reference voltage circuit and is configured to receive the second reference voltage and generate a second ground voltage based on the second reference voltage. The first power supply voltage is higher than the second power supply voltage. The second ground voltage is between the first power supply voltage and the second power supply voltage.

Yet another aspect of the present disclosure provides a method. The method includes the following steps: generating a reference voltage from a first power supply voltage and a second power supply voltage, wherein the first power supply voltage is higher than the second power supply voltage; regulating the reference voltage to generate a first ground voltage; converting a first voltage signal in a first voltage domain to generate a second voltage signal in a second voltage domain; and buffering the second voltage signal to generate a third voltage signal; and operating a first circuit and a second circuit in the first voltage domain and the second voltage domain, respectively. The first voltage domain ranges from a second ground voltage to the second power supply voltage. The second voltage domain ranges from the first ground voltage to the first power supply voltage. The first voltage signal equals to the second power supply voltage minus the second ground voltage.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. A voltage supply circuit, comprising:
a reference voltage circuit, configured to receive a first power supply voltage and a second power supply voltage, and a first ground voltage, and configured to generate a reference voltage based on the first power supply voltage and the second power supply voltage; and
a voltage regulator, coupled to the reference voltage circuit, and configured to receive the reference voltage, and generate a second ground voltage based on the reference voltage,
wherein the first power supply voltage is higher than the second power supply voltage,
wherein the second ground voltage is between the first power supply voltage and the second power supply voltage.

2. The voltage supply circuit of claim 1, wherein the reference voltage equals to the first power supply voltage minus the second power supply voltage.

3. The voltage supply circuit of claim 2, wherein the voltage supply circuit comprises a first logic and a second logic operating in a first voltage domain and a second voltage domain different from the first voltage domain.

4. The voltage supply circuit of claim 3, wherein the first voltage domain is higher than the second voltage domain.

5. The voltage supply circuit of claim 4, wherein:
the first voltage domain ranges from the second ground voltage to the first power supply voltage; and
the second voltage domain ranges from the first ground voltage to the second power supply voltage.

6. The voltage supply circuit of claim 5, wherein:
the first logic comprises a plurality of first devices, and the second logic comprises a plurality of second devices; and
each of the plurality of first devices and the plurality of second devices has a predetermined stress voltage threshold.

7. The voltage supply circuit of claim 6, wherein a voltage difference between the first power supply voltage and the first ground voltage is higher than the predetermined stress voltage threshold.

8. The voltage supply circuit of claim 4, further comprising:
a level shifter, configured to receive the first power supply voltage, the first ground voltage, the second ground voltage, and a first voltage, and configured to convert the first voltage to a second voltage;
a buffer, coupled to the level shifter, and configured to receive the second voltage, and generate a third voltage from the second voltage; and
the first voltage is within the second voltage domain.

9. The voltage supply circuit of claim 8, wherein the first voltage equals to the second power supply voltage minus the first ground voltage.

10. The voltage supply circuit of claim 1, wherein the reference voltage circuit comprises:
a first transistor, having a gate coupled to a first node receiving the second power supply voltage through a first resistor, a drain coupled to the first node, and a source configured to receive the first ground voltage;
a second transistor, having a gate coupled to the first node, a drain coupled to a second node, and a source configured to receive the first ground voltage;
a third transistor, having a gate coupled to an output terminal of reference voltage circuit, a drain coupled to the output terminal, and a source coupled to the drain of the second transistor; and
a fourth transistor, having a gate coupled a third node, a drain configured to receive the first power supply voltage at the third node through a second resistor, and a source coupled to the output terminal.

11. The voltage supply circuit of claim 10, wherein a first current flowing through the first resistor and the first transistor equals to a second current flowing through the fourth transistor, the third transistor, and the second transistor.

12. The voltage supply circuit of claim 1, wherein the voltage regulator comprises:
an input stage, configured to mirror a first bias current to generate a second bias current;
an differential amplifier, configured to receive the reference voltage and the second ground voltage, and generate a voltage signal; and
an output stage, coupled to the input stage and the differential amplifier, and configured to be driven by the voltage signal to generate the second ground voltage.

13. The voltage supply circuit of claim 12, wherein:
the input stage comprises a first first-type transistor, a second first-type transistor, a first second-type transistor, and a second second-type transistor arranged in a first cascoded structure in sequence;
the second first-type transistor is controlled by the second power supply voltage; and
the first second-type transistor and the second second-type transistor are in diode-connected configurations.

14. The voltage supply circuit of claim 13, wherein:
the output stage comprises a third first-type transistor, a fourth first-type transistor, a third second-type transistor, and a fourth second-type transistor arranged in a second cascoded structure in sequence;
the third first-type transistor is driven by the voltage signal;
the third second-type transistor and the first second-type transistor form a first current mirror; and
the fourth second-type transistor and the second second-type transistor form a second current mirror.

15. A voltage supply circuit, comprising:
a reference voltage circuit, configured to receive a first power supply voltage and a second power supply voltage, and a first ground voltage, and configured to generate a first reference voltage based on the first power supply voltage and the second power supply voltage;
a voltage divider, coupled to the reference voltage circuit, and configured to receive the first reference voltage and divide the first reference voltage by a predetermined factor to generate a second reference voltage; and
a voltage regulator, coupled to the reference voltage circuit, and configured to receive the second reference voltage, and generate a second ground voltage based on the second reference voltage,
wherein the first power supply voltage is higher than the second power supply voltage,
wherein the second ground voltage is between the first power supply voltage and the second power supply voltage.

16. The voltage supply circuit of claim 15, wherein the first reference voltage equals to the first power supply voltage minus the second power supply voltage.

17. The voltage supply circuit of claim 16, wherein the voltage supply circuit comprises a first logic and a second logic operating in a first voltage domain and a second voltage domain lower than the first voltage domain.

18. The voltage supply circuit of claim 17, wherein:
the first voltage domain ranges from the second ground voltage to the first power supply voltage; and
the second voltage domain ranges from the first ground voltage to the second power supply voltage.

19. The voltage supply circuit of claim 15, wherein a voltage difference between the first power supply voltage and the first ground voltage is higher than a predetermined stress voltage threshold.

20. A method, comprising:
generating a reference voltage from a first power supply voltage and a second power supply voltage, wherein the first power supply voltage is higher than the second power supply voltage;
regulating the reference voltage to generate a first ground voltage;
converting a first voltage signal in a first voltage domain to generate a second voltage signal in a second voltage domain; and
buffering the second voltage signal to generate a third voltage signal; and
operating a first circuit and a second circuit in the first voltage domain and the second voltage domain, respectively,
wherein the first voltage domain ranges from a second ground voltage to the second power supply voltage,
wherein the second voltage domain ranges from the first ground voltage to the first power supply voltage,
wherein the first voltage signal equals to the second power supply voltage minus the second ground voltage.
